(19) United States
(12) Patent Application Publication
(10) Pub. No.: US 2026/0188291 A1
(43) Pub. Date: Jul. 2, 2026

(54) HEADPHONE DEVICE AND WEARABLE DEVICE

(71) Applicant: Sony Interactive Entertainment Inc., Tokyo (JP)

(72) Inventor: Morio Kakiuchi, Kanagawa (JP)

(21) Appl. No.: 19/550,100

(22) Filed: Feb. 25, 2026

Related U.S. Application Data
(63) Continuation of application No. PCT/JP2023/031040, filed on Aug. 28, 2023.

(51) Int. Cl. G10K 11/178; H04R 1/10

(52) U.S. Cl. CPC G10K 11/178; H04R 1/1008

(57) ABSTRACT

A wearable device including a pair of airflow control units or fan units provided for each ear of a wearer, wherein the wearable device controls the airflow control units or the fan units based on airflow control instructions received from an information processing device 1, and causes the wearer to sense airflow in their auricles.

### CROSS-REFERENCE TO RELATED APPLICATIONS

This application is a Continuation of International Application No. PCT/JP2023/031040, having an International Filing Date of Aug. 28, 2023. This disclosure of the prior application is considered part of the disclosure of this application.

### FIELD

The present specification relates to a headphone device and a wearable device worn by a wearer.

### BACKGROUND

In recent years, devices that present airflow to viewers of movies and the like to enhance the sense of realism have come into widespread use. Such a device is placed near the chairs where audience members sit in, for example, a movie theater, and in response to signals output in conjunction with the progress of the movie, drives a large fan positioned facing the audience to present an airflow to the audience.

### SUMMARY

However, there is a problem in that such devices are large and not portable, and it is difficult to present different airflows to each individual, limiting their applications.

The present specification has been made in consideration of the above circumstances, and an object thereof is to provide a headphone device and a wearable device that can be worn by a user and that can present an airflow to the user wearing such.

One aspect of the present specification that solves the problems of the conventional example described above is a headphone device having a pair of housing units provided for each ear of a wearer, each of the housing units provided with: an ear pad forming an air chamber that covers the ear, a speaker unit disposed in the air chamber, and an airflow control unit that controls airflow in the air chamber.

Another aspect of the present specification is a wearable device, provided with: a mounting member that can be attached to a wearer's head or neck, a pair of fan units provided for each ear of the wearer, and a control circuit portion that receives information from an information processing device and controls the fan units, wherein the control circuit drive controls of each of the pair of fan units based on the information received from the information processing device.

According to the present specification, the device can be worn by a user and can present an airflow to the user wearing it.

### BRIEF DESCRIPTION OF THE DRAWINGS

FIG. 1 is a schematic perspective view illustrating an example of a headphone device according to an implementation of the present specification.

FIG. 2 is a schematic cross-sectional view of a housing unit of the headphone device according to an implementation of the present specification.

FIG. 3 is a block diagram illustrating a configuration example of a control circuit portion of the headphone device according to an implementation of the present specification.

FIG. 4 is a schematic explanatory diagram illustrating an example of a wearable device according to an implementation of the present specification.

FIG. 5 is a block diagram illustrating a configuration example of a control circuit portion of the wearable device according to an implementation of the present specification.

FIG. 6 is an explanatory diagram illustrating an operation example of a fan unit in the wearable device according to an implementation of the present specification.

### DETAILED DESCRIPTION

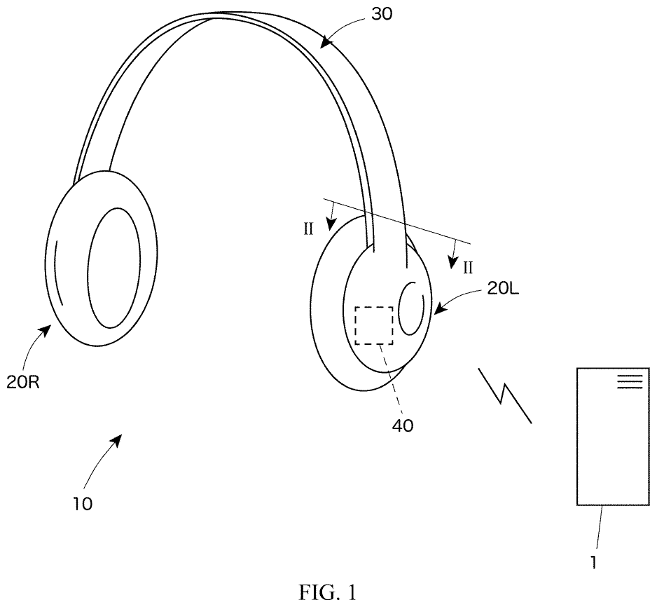

An implementation of the present specification will be described with reference to the drawings. A wearable device according to an implementation of the present specification is realized as a headphone device 10, as illustrated in FIG. 1.

This headphone device 10 is configured to include a pair of housing units 20L and 20R, a pair of housing units 20 (hereinafter, when there is no need to distinguish between housing units 20L and 20R, they will be referred to as housing units 20) connected together, a mounting member 30 that is fixed to a head of a user (a wearer), and a control circuit portion 40. In addition, the headphone device 10 is connected to an information processing device 1 via wire or wirelessly so as to be able to communicate with the information processing device 1.

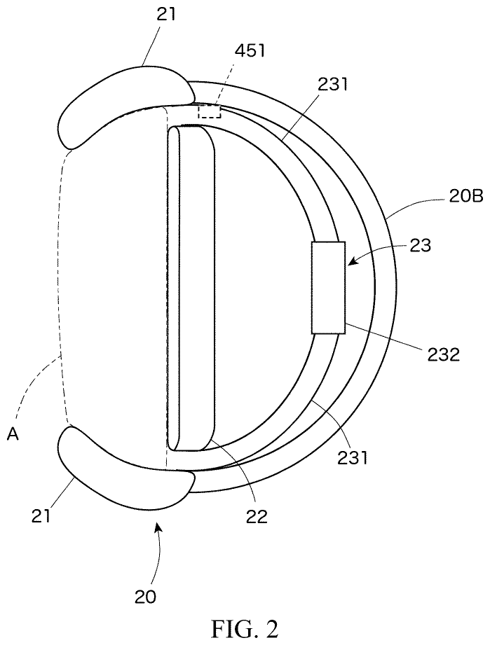

FIG. 2 is a schematic cross-sectional view of the housing unit 20. FIG. 2 illustrates a cross-section taken along a plane parallel to the coronal plane of the user wearing the headphone device 10. The housing unit 20 is composed of a material such as plastic or the like and includes an exterior body 20B having a substantially hollow hemispherical shape, ear pads 21 disposed along the opening of the exterior body 20B and forming an air chamber A covering the ears of the wearer, a speaker unit 22 disposed in the air chamber A, and an airflow control unit 23 for controlling airflow in the air chamber A.

In addition, the control circuit portion 40 of the headphone device 10 may also be housed in one of the housing units 20L and 20R.

In the example of FIG. 2, the airflow control unit 23 is provided with an airflow path 231 having a pair of openings P and Q disposed at opposing positions across the ears of the wearer of the air chamber A and formed to connect these openings P and Q to each other outside the air chamber A, and a fan unit 232 disposed in the airflow path 231 and forming an airflow in at least one direction within the airflow path 231, and the airflow in the air chamber A is controlled by the fan unit 232.

However, this is just one example, and the airflow control unit 23 is not limited to the example in FIG. 2 and may be any type as long as it can present an airflow to at least a part of the wearer's ear (auricle).

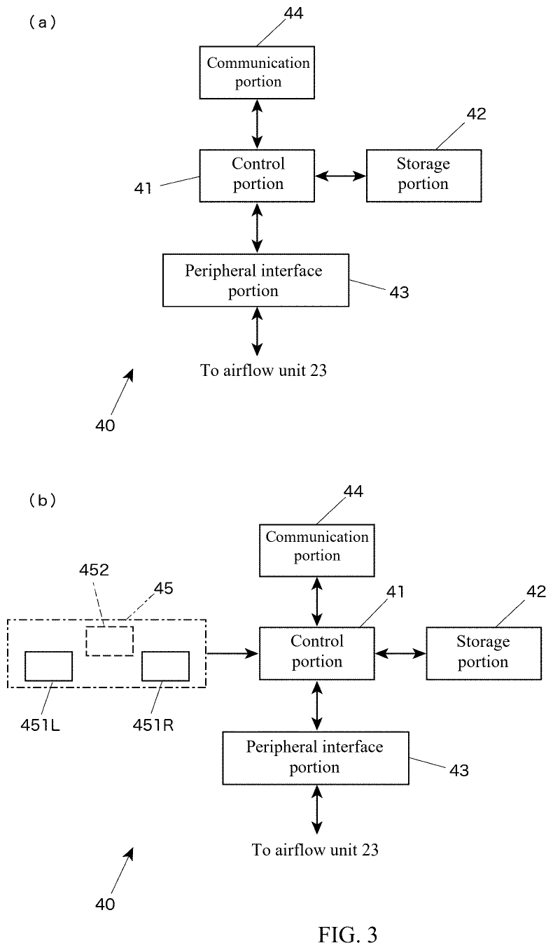

As illustrated in FIG. 3(a), the control circuit portion 40 includes a control portion 41, a storage portion 42, a peripheral interface portion 43, and a communication portion 44. The control portion 41 is a program-controlled device such as a microcomputer or the like, and operates according to a program (firmware) stored in the storage portion 42. In this implementation, the control portion 41 generates an audio signal from the audio information received from the information processing device 1 and controls the speaker units 22 disposed in each of the housing units 20L and 20R to sound (for this reason, the control circuit portion 40 and each speaker unit 22 are assumed to be electrically connected).

In addition, one of the features of this implementation is that the control portion 41 controls the airflow control unit 23. An example of this control will be described below.

The storage portion 42 is a memory device that stores programs executed by the control portion 41 and also operates as a work memory for the control portion 41. This program may be provided by being stored in a computer-readable, non-transitory recording medium, and may be copied into the storage portion 42.

The peripheral interface portion 43 is electrically connected to the airflow control unit 23. The peripheral interface portion 43 receives instructions to control the airflow control units 23 from the control portion 41, and controls the airflow control units 23 disposed in the housing units 20L and 20R in accordance with the instructions. An example of this control will also be described below.

The communication portion 44 is communicably connected to the information processing device 1 via a wired interface such as a USB (Universal Serial Bus) or a wireless interface such as Bluetooth (registered trademark). The communication portion 44 receives voice information from the information processing device 1 and outputs it to the control portion 41. In addition, the communication portion 44 also receives instructions for controlling the airflow (airflow control instructions) input from the information processing device 1 and outputs them to the control portion 41. In addition, the communication portion 44 may transmit various information to the information processing device 1 in accordance with an instruction input from the control portion 41.

Next, an example of a control operation of the airflow control unit 23 by the control circuit portion 40 will be described. In one example of the present implementation, the headphone device 10 includes the airflow control unit 23 as illustrated in FIG. 2. The control portion 41 of the control circuit portion 40 accepts the airflow control instruction received by the communication portion 44 from the information processing device 1.

Here, the airflow control instruction may be, for example, binary information indicating whether the airflow is on or off, or information indicating a strength of the airflow (flow rate per unit time). In addition, the airflow control instruction may also be information for changing the strength of the airflow over time.

The control portion 41 controls the amount of current supplied to the fan unit 232 of the airflow control unit 23 in accordance with the received airflow control instruction, and drives the fan of the fan unit 232. Then, the fan unit 232 generates an airflow in the airflow path 231 and controls the airflow in the air chamber A that is connected to the airflow path 231.

### Operation

The headphone device 10, which is an example of the wearable device of the present implementation, is substantially provided with the above configuration and operates as in the following example. In the following example, it is assumed that the information processing device 1 is executing a game program, and that a player of a game is wearing the headphone device 10.

In addition, in this game program, airflow control information to be output for each game scene is stored in association with each other. In this example, the game progresses in response to the player's operations, and each time a game scene changes, the information processing device 1 acquires airflow control information associated with the game scene after the change. Then, the information processing device 1 then sends the acquired airflow control information to the headphone device 10 worn by the player.

The headphone device 10 turns on or off the fan unit 232 of the airflow control unit 23 based on the airflow control information received from the information processing device 1. For example, in a game in which the player switches back and forth between an indoor game scene associated with airflow control information indicating that the airflow should be turned off and an outdoor game scene associated with airflow control information indicating that the airflow should be turned on, while the player's character is indoors, the headphone device 10 receives airflow control information indicating that the airflow should be turned off from the information processing device 1 and turns off the fan unit 232 of the airflow control unit 23. At this time, the airflow in the air chambers A of the headphone device 10 stagnates, and the player's ears cannot sense the airflow. In addition, when the player's character moves outdoors, the information processing device 1 sends airflow control information to turn on the airflow, and the headphone device 10 receives this airflow control information and turns on the fan unit 232 of the airflow control unit 23. This generates an airflow in the air chamber A of the headphone device 10, and the player feels as if wind is blowing against their ears.

In this way, in this example of the present implementation, scenes in which the user feels airflow and scenes in which the user does not feel airflow can be presented as the game progresses.

### Fan Noise Reduction

In addition, the control circuit portion 40 of the headphone device 10, which is an example of the wearable device of the present implementation, may be further provided with a detection part 45 in addition to the control portion 41, the storage portion 42, the peripheral interface portion 43, and the communication portion 44, as exemplified in FIG. 3(b).

This detection part 45 may include a pair of microphone units 451L and 451R that are disposed within each of the housing units 20L and 20R closer to the fan unit 232 of the airflow control unit 23 than the speaker unit 22 and that detect the sound generated by the fan unit 232.

For example, the microphone unit 451 in this example (which will be referred to as such when there is no need to distinguish between the microphone units 451L and 451R) may be disposed in the airflow path 231 within the corresponding housing unit 20 (whether to dispose it upstream or downstream of the airflow generated by the fan unit 232 may be determined experimentally as appropriate).

In this example, the control portion 41 acquires, from the microphone units 451L and 451R in each of the housing units 20L and 20R, an audio signal (referred to as an L-side noise signal and an R-side noise signal, respectively) representing the sound detected by the respective microphone units 451L and 451R. Then, when the control portion 41 generates an audio signal from the audio information received from the information processing device 1, it corrects the audio signal by delaying only a predetermined time and adding an audio signal that is in the reverse phase to the L-side noise signal to the audio signal that sounds the speaker unit 22L in the housing unit 20L, and outputs the audio signal to the speaker unit 22L to sound an audio based on a corrected audio signal.

Similarly to the above, the control portion 41 corrects the audio signal by adding an audio signal that is the reverse phase of the R-side noise signal to the audio signal that causes the speaker unit 22R in the housing unit 20R to sound from among the generated audio signals, and outputs the audio signal to the speaker unit 22R to sound audio based on the corrected audio signal. Here, the delay time may be different depending on whether the audio signal is output to either of the left and right speaker units 22L and 22R, and may be determined experimentally or may be adjustable by the user. When the user makes an adjustment, the user may instruct a setting via the information processing device 1.

According to this example of the present implementation, fan noise (such as fan motor noise or the like) included in the fan unit 232 can be canceled, reducing a chance that the user who wears the earphone will hear unintended noise.

### Audio Information Correction According to Fan Rotation Speed

In addition, a reduction in the fan noise is not limited to a device using a microphone as described above. In another example of the present implementation, the detection part 45 may include, together with the microphone unit 451, a rotation speed detector 452 that acquires information related to the rotation speed of the fan, such as the amount of current supplied to a motor that drives the fan of the fan unit 232 and a rotary encoder or the like that detects the rotation speed of the motor.

In this example, the control portion 41 acquires, from the microphone units 451L and 451R, the audio signal (referred to as the L-side noise signal and the R-side noise signal, respectively) representing the sound detected by the respective microphone units 451L and 451R in each of the housing units 20L and 20R, and acquires information related to a rotational speed of the motors of the fan units 232L and 232R (hereinafter referred to as L-side rotation speed information and R-side rotation speed information, respectively).

Then, when an audio signal from the audio information received from the information processing device 1 is generated, to the audio signal sounded by the speaker unit 22L in the housing unit 20L of the generated audio signals, using the L-side noise signal and the L-side rotation speed information, the control portion 41 generates a sound that is the reverse phase of the fan sound of the fan unit 232L (L-side reverse phase sound), corrects the audio signal by delaying for only a predetermined period of time and adding the generated L-side phase sound, outputs to the speaker unit 22L, and sounds audio based on a corrected audio signal.

Similarly, to the audio signal sounded by the speaker unit 22R in the housing unit 20R of the generated audio signals, using the R-side noise signal and the R-side rotation speed information, the control portion 41 generates a sound that is the reverse phase of the fan sound of the fan unit 232R (R-side reverse phase sound), corrects the audio signal by delaying for only a predetermined period of time and adding the generated R-side phase sound, outputs to the speaker unit 22R, and sounds audio based on a corrected audio signal.

Even in this example, the delay time may be different depending on whether it is an audio signal output to either of the left and right speaker units 22L and 22R, and the time may be determined experimentally or may be adjustable by the user. When the user makes an adjustment, the user may instruct the setting via the information processing device 1.

According to this example of the present implementation, the fan noise (such as the fan motor noise or the like) included in the fan unit 232 can be canceled, reducing the chance that the user who wears the earphone will hear unintended noise.

Note that, in generating the reverse phase sound, for example, an intensity of the corresponding noise signal may be corrected or the like based on the corresponding rotation speed information (for example, the greater the rotation speed indicated by the rotation speed information, the greater the correction to the intensity of the noise signal).

In addition, if the rotation speed detector 452 that detects the rotation speed of the motor is provided in this manner, the microphone unit 451 is not necessarily required, and if the microphone unit 451 is not provided, the reverse phase sound may be estimated and obtained according to information related to the rotation speed. The method of this estimation is not limited, and the estimation may be performed by changing an intensity of white noise according to the rotation speed, or by using a machine learning model or the like.

### Another Form of the Wearable Device

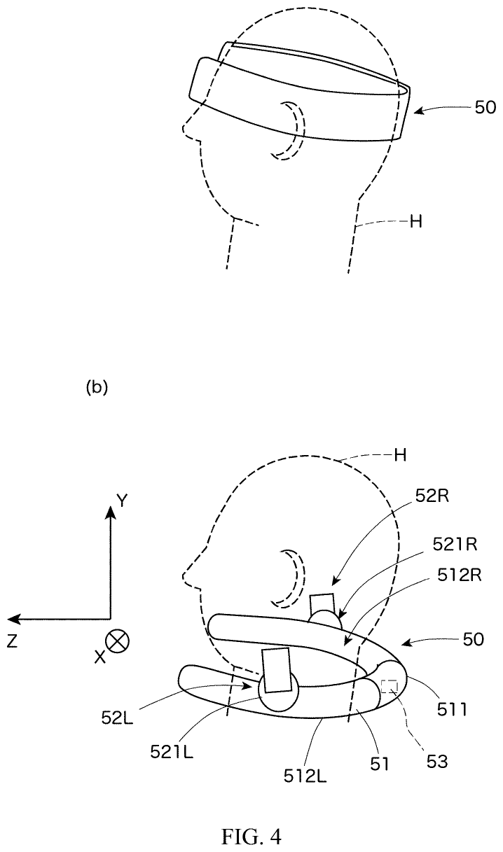

In addition, the wearable device according to an example of the present implementation may be realized as the headphone device 10 or may be locked to the head or neck of the wearer as in the following example. A wearable device 50 according to another example of this implementation may be a headgear device that is fastened to the head of a user H, as illustrated in FIG. 4(a), or may be a neckband-like device that is fastened to the neck of the user, as illustrated in FIG. 4(b). In the example of FIG. 4(a), a cap-shaped member fixed to the user's head corresponds to the wearing member, and in the example of FIG. 4(b), a crescent-shaped member that engages with the user's neck corresponds to a mounting member 51. The following description will be given using the example of FIG. 4(b).

As illustrated in FIG. 4(b), the wearable device 50 in this example is composed of at least the crescent-shaped mounting member 51 that is attached to the area from the back of the user's neck (nape) to left and right sides of the neck, a pair of fan units 52L and 52R that are provided for each ear of the wearer, and a control circuit portion 53.

Here, as illustrated in FIG. 4(b), the mounting member 51 is formed to include a central portion 511 that contacts a back of the user's neck, a left wing portion 512L that extends from this central portion 511 along the user's neck to its left side, and a right wing portion 512R that extends from the central portion 511 along the user's neck to its right side.

The wing portions 512L and 512R may be configured so that a portion of the central portion 511 side can be inserted into the central portion 511 to a desired length by the user, and may be fixed at a position where the desired length has been inserted. This may allow a distance between wing portions 512L and 512R to become adjustable, and may allow the user to adjust the mounting member 51 to fit a diameter of their neck.

The fan units 52L and 52R each include a fan that generates an airflow in a predetermined ventilation direction, and are attached to the wing portions 512L and 512R of the mounting member 51 via joints 521L and 521R, respectively. The joints 521L and 521R may be rotatable within a predetermined angle range, using at least an axial direction facing the neck of the user as the rotation axis. When the ventilation direction of the fan units 52L and 52R is rotatable around the axis, the user adjusts rotation angles of the joints 521L and 521R so that the airflow generated by the fan units 52L and 52R hits the user's left and right ears, respectively. However, this is just one example, and the angle of the fan units 52L and 52R may be fixed so that when an average adult wears the wearable device 50, the airflow generated by the fan units 52L and 52R hits the left and right ears of the wearer.

The fan units 52L and 52R each rotate the fan in accordance with an instruction input from a control circuit portion 53, which will be described below, to generate an airflow.

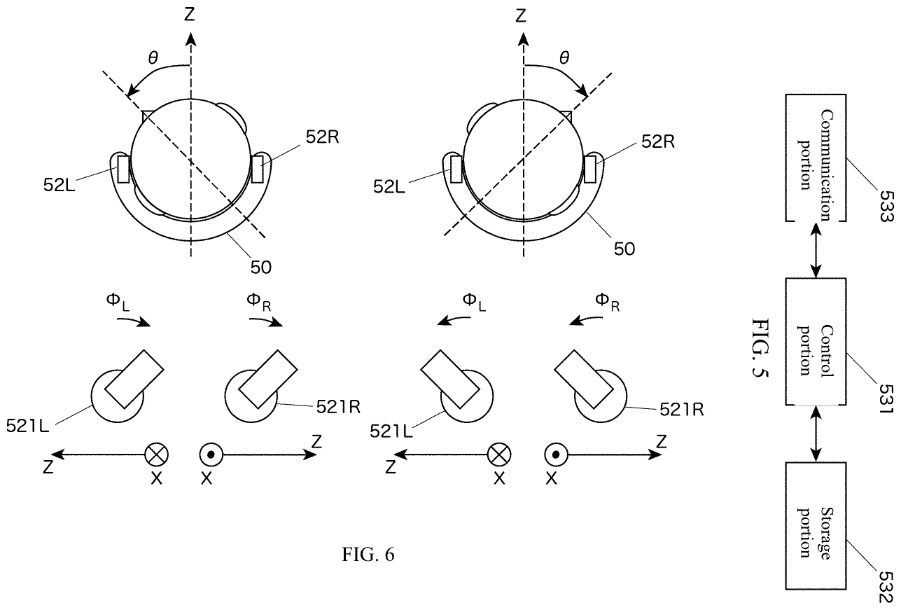

As exemplified in FIG. 5, the control circuit portion 53 includes a control portion 531, a storage portion 532, and a communication portion 533.

The control portion 531 of this example of the present implementation is, for example, a program control device such as a microcomputer and operates according to a program (firmware) stored in the storage portion 532. The control portion 531 in this example of the present implementation controls the fan units 52L and 52R in accordance with the instruction input from the information processing device 1. An example of this control will be described below.

The storage portion 532 is, for example, a memory device, holds programs executed by the control portion 531, and operates as a work memory of the control portion 531. The program is provided stored in a computer-readable, non-transitory recording medium and may be copied to this storage portion 532.

The communication portion 533 is connected to the information processing device 1 so as to be able to communicate via a wired device such as USB (Universal Serial Bus) or the like, or a wireless interface such as Bluetooth (registered trademark) or the like. The communication portion 533 receives an instruction (airflow control instruction) for controlling the airflow input from the information processing device 1 and outputs such to the control portion 531. In addition, the communication portion 533 may also send various information to the information processing device 1 in accordance with an instruction input from the control portion 531.

Next, an example of the control operation of the fan units 52L and 52R by the control portion 531 will be described. In the example of the present implementation, as in the case of the headphone device 10, this airflow control indication may be, for example, binary information representing whether the airflow is turned on or off, or information representing the strength of the airflow (flow rate per unit time). In addition, the airflow control instruction may also be information for changing the strength of the airflow over time.

The control portion 531 controls the amount of current supplied to each of the fan units 52L and 52R in accordance with the received airflow control instruction to drive or brake fans of the fan units 52L and 52R. Then, when the fans are driven, the fan units 52L and 52R generate airflow, which is directed at at least a part of the user's ear (auricle), allowing the user to feel the airflow.

### Adjusting the Ventilation Direction

In addition, in the case of wearable device 50 that is fastened to the back of the neck as in this example, the ventilation direction from fan units 52L and 52R and the position of the user's ears change depending on an orientation of the wearer's head. Therefore, in one example of this implementation, actuators may be provided in the joints 521L and 521R, and the control portion 531 may be able to control the ventilation direction of the fan units 52L and 52R.

In this example, an axis (normal to the coronal plane) pointing in the direction of the user's head (the front of the body, in other words, from the center of the back of the neck where the wearable device 50 is attached to the front of the user) is defined as the Z-axis, a normal direction from feet to the head in the cross-sectional plane is defined as the Y-axis, and a normal direction from the left to the right of the user in the sagittal plane is defined as the X-axis, and information on a rotation angle θ from the Z-axis when the user's head rotates around the Y-axis is obtained.

This rotation angle θ may be obtained, for example, by connecting a camera to the information processing device 1 to capture an image of the user and estimating the direction of the user's head based on the captured image, or by employing any of various other well-known methods for detecting the direction of the user's head.

When the information processing device 1 obtains information on the rotation angle θ, the information processing device 1 generates information representing the rotation angles of the joints 521L and 521R based on the information representing the rotation angle θ. For example, the information processing device 1 defines a range of the rotation angle θ of the user's neck as between −180 degrees and 180 degrees (the counterclockwise direction when viewed from above on the Y-axis is the positive angle direction), and calculates a rotation angle ΦL of the joint 521L (when viewed from the negative direction of the X-axis to the positive direction, the counterclockwise direction around the X-axis is the positive direction, and the Z-axis direction is 0 degrees) as

$$Φ L = - α \times θ + β ,$$

and similarly, a rotation angle ΦR of the joint 521R (when viewed from the positive direction of the X-axis to the negative direction, the counterclockwise direction around the X-axis is the positive direction, and the Z-axis direction is 0 degrees) is defined as

$$Φ R = - α \times θ + γ .$$

Note that α, β, and γ are determined appropriately experimentally. However, β and γ may be adjusted as initial positions when the user faces their head forward (in the Z-axis direction) (the tip of their nose is facing in the Z-axis direction), in other words, so that the ventilation direction of each fan unit 52L and 52R hits the auricle of the corresponding ear at that time. In this example, when the user faces their head forward (in the Z-axis direction), θ=0, and therefore ΦL=β, ΦR=γ. Then, when the user turns their head to the left (θ>0) without changing the orientation of their body as illustrated in FIG. 6(a), ΦL and ΦR are tilted by −αθ (this value becomes negative) from the initial angles β and γ, respectively. In other words, when viewed from the negative direction of the X-axis to the positive direction, the rotation angle of joint 521L rotates clockwise around the X-axis to follow the movement of the left ear. Similarly, the rotation angle of the joint 521R, when viewed in the positive direction from the X-axis negative direction, rotates in the clockwise direction around the X-axis to follow the movement of the right ear.

In addition, conversely, when the user faces the head only to the right (θ<0) without turning the body as in FIG. 6(b), ΦL and ΦR are tilted by −αθ (this value becomes positive) from the initial angles β and γ, respectively. In this case, the rotation angle of the joint 521L, when viewed in the positive direction from the X-axis negative direction, rotates in the counterclockwise direction around the X-axis to follow the movement of the left ear. Similarly, the rotation angle of the joint 521R, when viewed from the X-axis negative direction in a positive direction, rotates in a counterclockwise direction around the X-axis to follow the movement of the right ear.

### Additional Configuration Provided on Contact Portion

In addition, the headphone device 10 or the wearable device 50 of the present implementation may have an element (such as a Peltier element) that heats or absorbs heat at a contact portion that comes into contact with the wearer. Furthermore, the headphone device 10 and the wearable device 50 may include a vibrator (vibration element) inside a housing thereof.

In the case of the headphone device 10, a band may be placed around the back of the neck of the wearer to form the contact portion. When the headphone device 10 is worn, at least a part of the band comes into contact with the back of the neck of the wearer. In this example, the element that heats or absorbs heat at the contact portion of the band is disposed at a position where the band contacts the back of the neck of the wearer.

In addition, for example, in the case of the wearable device 50 that is fastened to the back of the neck of the wearer, the element that heats or absorbs heat from the contact portion is disposed on a side of the central portion 511 that comes into contact with the back of the neck of the wearer, as illustrated in FIG. 4(b).

In these examples, the headphone device 10 and the wearable device 50 use the above elements to heat or absorb heat from the contact portion in accordance with the instructions input from the information processing device 1. The information processing device 1 allows the wearer of the headphone device 10 or the wearable device 50 to feel an airflow at the auricle, and can also use this element to give the wearer a sensation of warmth or coolness.

Furthermore, even when the vibration element is provided, the headphone device 10 or the wearable device 50 controls a vibration waveform presented to the wearer, such as a vibration amount and a duration of the vibration of the vibration element, in accordance with the instructions input from the information processing device 1.

According to this implementation, the device is configured to allow the wearer to sense the airflow in their auricle, so that a relatively small device that can be worn by the user can present the wearer with an airflow that is determined for each wearer.

### DESCRIPTION OF REFERENCE NUMERALS

1 Information processing device, 10 Headphone device, 20 Housing unit, 21 Ear pad, 22 Speaker unit, 23 Airflow control unit, 30, 51 Mounting member, 40, 53 Control circuit portion, 41, 531 Control portion, 42, 532 Storage portion, 43 Peripheral interface portion, 44, 533 Communication portion, 45 Detection part, 50 Wearable device, 52, 232 Fan unit, 231 Airflow path, 451 Microphone unit, 452 Rotation speed detector, 511 Central portion, 512 Wing portion, 521 Joint.

What is claimed is:

1. A headphone device having a pair of housing units provided for each ear of a wearer, each of the housing units comprising:
an ear pad forming an air chamber that covers the ear;
a speaker unit disposed in the air chamber; and
an airflow control unit that controls airflow in the air chamber.

2. The headphone device of claim 1, wherein the airflow control unit comprises:
an airflow path having a pair of openings disposed in the air chamber at positions facing each other across the wearer's ears; and
a fan unit disposed in the airflow path to form an airflow in at least one direction within the airflow path.

3. The headphone device of claim 2, comprising:
a circuit portion that receives an input of an audio signal emitted by the speaker unit and that causes the speaker unit to sound based on the audio signal; and
a microphone unit disposed closer to the fan unit than the speaker unit and detects sound generated by the fan unit,
wherein the circuit portion corrects the input audio signal to cancel the sound emitted by the fan unit detected by the microphone unit, and causes the speaker unit to sound based on a corrected audio signal.

4. The headphone device of claim 2, comprising:
a circuit portion that receives an input of an audio signal emitted by the speaker unit and that causes the speaker unit to sound based on the audio signal;
a microphone unit disposed in a vicinity of the fan unit that detects sounds generated by the fan unit; and
a detection part that acquires information related to a fan rotation speed provided by the fan unit,
wherein the circuit portion corrects the input audio signal based on the sound detected by the microphone unit and the information acquired by the detection part so as to cancel the sound generated by the fan unit, and causes the speaker unit to sound based on a corrected audio signal.

5. The headphone device of claim 1, comprising a control circuit portion that receives information from an information processing device and controls the fan unit.

6. The headphone device of claim 1, comprising an element for heating or absorbing heat at a contact portion that contacts the wearer.

7. A wearable device comprising:
a mounting member that can be attached to a wearer's head or neck,
a pair of fan units provided for each ear of the wearer, and
a control circuit portion that receives information from an information processing device and controls the fan units,
wherein the control circuit portion controls of each of the pair of fan units based on the information received from the information processing device.

8. The wearable device of claim 7, wherein:
the control circuit portion controls a ventilation intensity of each of the pair of fan units, and
a ventilation direction of each fan unit based on the information received from the information processing device.

9. The wearable device of claim 8, wherein:
the fan unit is attached to the mounting member via a joint portion,
an angle of the ventilation direction is modifiable with respect to the mounting member, and
the control circuit portion drives the joint portion based on the information received from the information processing device to control the ventilation direction of each of the fan units.

10. The wearable device of claim 7, wherein the mounting member is further provided with an element for heating or absorbing heat.

11. A method comprising:
providing an ear pad forming an air chamber that covers an ear;
disposing a speaker unit in the air chamber; and
controlling, by an airflow control unit, airflow in the air chamber.

12. The method of claim 1, wherein the airflow control unit comprises:
an airflow path having a pair of openings disposed in the air chamber at positions facing each other across the wearer's ears; and
a fan unit disposed in the airflow path to form an airflow in at least one direction within the airflow path.

13. The method of claim 12, comprising:
receiving, by a circuit portion, an input of an audio signal emitted by the speaker unit;
causing the speaker unit to sound based on the audio signal;
detecting, by a microphone unit disposed closer to the fan unit than the speaker unit, sound generated by the fan unit;
correcting, by the circuit portion, the input audio signal to cancel the sound emitted by the fan unit detected by the microphone unit; and
causing the speaker unit to sound based on a corrected audio signal.

14. The method of claim 12, comprising:
receiving, by a circuit portion, an input of an audio signal emitted by the speaker unit;
causing the speaker unit to sound based on the audio signal;
detecting, by a microphone unit disposed in a vicinity of the fan unit, sounds generated by the fan unit;
acquiring, by the detection part, information related to a fan rotation speed provided by the fan unit;
correcting, by the circuit portion, the input audio signal based on the sound detected by the microphone unit and the information acquired by the detection part so as to cancel the sound generated by the fan unit; and
causing the speaker unit to sound based on a corrected audio signal.

15. The method of claim 11, comprising:
receiving, by a control circuit portion, information from an information processing device; and
controlling the fan unit.

16. The method of claim 11, comprising heating or absorbing heat at a contact portion that contacts the wearer.

17. A method comprising:
a mounting member that can be attached to a wearer's head or neck,
a pair of fan units provided for each ear of the wearer, and
a control circuit portion that receives information from an information processing device and controls the fan units,
wherein the control circuit portion controls of each of the pair of fan units based on the information received from the information processing device.

18. The method of claim 17, comprising:
controlling a ventilation intensity of each of the pair of fan units, and
controlling a ventilation direction of each fan unit based on the information received.

19. The method of claim 18, comprising:
attaching the fan unit to the mounting member via a joint portion,
modifying an angle of the ventilation direction with respect to the mounting member, and
driving the joint portion based on the information received from the information processing device to control the ventilation direction of each of the fan units.

20. The method of claim 17, heating or absorbing heat by the mounting member.
